(19) United States
(12) Patent Application Publication
(10) Pub. No.: US 2016/0109140 A1
(43) Pub. Date: Apr. 21, 2016

(54) CENTRAL HEATING SYSTEM

(71) Applicant: Linda BRANNIGAN, Laleham Middlesex (GB)

(72) Inventor: Alistair SMIT, Chelmsford, Essex (GB)

(21) Appl. No.: 14/894,641

(22) PCT Filed: May 29, 2014
(86) PCT No.: PCT/GB2014/051647

§ 371 Date: Nov. 30, 2015

(30) Foreign Application Priority Data
May 29, 2013 (GB) 1309598.9

(51) Int. Cl. F24D 19/08; F24D 3/10; B23P 11/00; F24D 3/02

(52) U.S. Cl. CPC F24D 19/083; F24D 3/02; F24D 3/105; B23P 11/00

(57) ABSTRACT

A central heating product comprises a vessel for plumbing between a boiler (7A) of a central heating system and one or more radiator circuits (7I) of the central heating system. The vessel comprises a boiler flow tapping (4A) at the top of the vessel for flow into the vessel from the boiler (7A), one or more boiler return tappings (2A, 3A) for return flow to the boiler (7A) from the vessel, and radiator tappings (1A,1B,1C,1D) for fluid connection with the one or more radiator circuits (7I). The vessel further comprises means for collecting gas/air for expulsion from the central heating system in the form of a bubble catchment area (5D) that is defined by an upper part of the vessel and provided under the boiler flow tapping (4A).

The present invention relates to a central heating product for a central heating system, a central heating system, and a method of installing or modifying a central heating system.

Existing wet-type central heating systems commonly exhibit deficiencies in the plumbing due to the way they were designed and/or because of output limitations or limitations of integral system components making the heating system run inefficiently. This ultimately causes more fuel to be burnt than necessary to adequately and efficiently raise the indoor air temperature to desired levels. In many cases the central heating system simply will not function properly and a solution does not currently exist to resolve this.

Existing wet-type central heating systems have to be balanced with the flow of liquid regulated through the system. It is commonly accepted that unwanted heat loss occurs due to space heating and losses within the system due to inertial losses. Common central heating system ailments include: sludge in system, gas/air in the system causing cold spots in radiators and knocking pipes, corrosion due to a chemical reaction between metal radiators and mineral content and gases imported with the water supply, insufficient water flow and reduced flow rate through the system, and inefficient boiler operation. Ultimately, these inefficiencies result in higher than necessary wall thermostat and boiler temperature settings to compensate for these inefficiencies.

Sludge is introduced into the system by suspended particles already found in the mains water supply, corrosion and flaking of material from piping and plumbing components and, in vented systems, by dirt entering the system via the expansion tank. Sludge affects the boiler efficiency with consequent higher fuel bills, invalidation of the boiler warranty, component failure and water flow restriction resulting in radiator ‘oldspots’.

Gas/air can be introduced into the central heating system by evaporation of dissolved gases due to heating. These gases are already present in the mains water supply. Air can also be drawn into the system due to changes in pressure in the system. This is due to the venturi effect where any restriction in the pipe cross-section will cause the liquid to speed up and create a lower-pressure area. Air can therefore be pulled into the system from air-vents, release valves or pipe joints.

Gas/air creates pressure changes within the piping and causes failure or inefficient running of the pumps found within the system and boiler. Gas/air also causes radiator ‘oldspots’ as it inhibits free running of the liquid and the introduction of oxygen accelerates chemical reactions, corrosion and breakdown of the central heating system.

Traditional wet-type central heating systems also suffer from severe peaks and troughs in oscillations in the temperature emitted from the radiators due to boiler switching. This then causes uneven radiator heating, reduced comfort and more fuel to be used by the boiler in running the system.

There are a few devices in the market that purport to offer a solution to one of the many problems that exist in a wet-type central heating system. These devices can be grouped under the main headings of, low loss headers, buffer tanks and deaerators. None of these devices however eliminate all of these problems. Low loss headers are tube structures with small cross-section, therefore their ability to mix the central heating liquid is very limited by the nature of their design. In addition the liquid flow is horizontally across the tube and therefore no appreciable time is available for gas/air to escape the flow.

There is a demand for a single device that solves these collective problems in a wet-type central heating system which will not only improve the comfort factor for the user, but will also help to improve the efficiency of fuel burning boilers, cut carbon dioxide emissions and help minimise global warming through reduced carbon being released.

Existing wet-type central heating systems therefore suffer from a variety of problems and inefficiencies. The invention is designed to reduce these and in many situations eliminate them.

According to the present invention there is provided a central heating product comprising a vessel for plumbing between a boiler of a central heating system and one or more radiator circuits of the central heating system, the vessel comprising:

a boiler flow tapping at the top of the vessel for flow into the vessel from the boiler;

one or more boiler return tappings for return flow to the boiler from the vessel;

radiator tappings for fluid connection with the one or more radiator circuits; and

means for collecting gas/air for expulsion from the central heating system, the means for collecting gas/air comprising a bubble catchment area that is defined by an upper part of the vessel and provided under the boiler flow tapping.

The present invention provides an energy saving central heating enhancement product which may be plumbed in between the central heating boiler and radiators. The invention therefore acts as a dividing point in the central heating system by divorcing direct contact between the boiler and radiators.

The invention comprises a vessel providing a unique natural and passive heat exchanger and system dampener. Preferred embodiments allow the flow through the radiator system to be increased and therefore improve room heat dissipation. Preferred embodiments also allow the difference between the temperature of the flow to the one or more radiator circuits and the temperature of the return flow from the one or more radiator circuits to be reduced when compared with standard systems. This means that the radiators of the one or more radiator circuits are more even in temperature across their surfaces. This in turn means that the radiators provide a greater amount of more comfortable and more efficient “radiated” heat at a lower temperature, rather than the less comfortable and less efficient “convected” heat at a higher temperature that is traditionally provided by radiators that are less even in temperature across their surfaces.

Preferred embodiments of the invention therefore allow the boiler temperature to be reduced without affecting the comfort factor of the user. This then means that the temperature of the boiler return flow can be under the relevant dew point (e.g. 55° C. or 57° C.) most, if not all, of the time, allowing a condensing boiler to condense efficiently most, if not all, of the time.

The vessel of embodiments of the present invention is designed to capture, and retain gas/air and then expel gas/air from the central heating systems. Any gas/air within the system may be continually collected and released into the atmosphere by a de-aerator when the boiler is turned off. Embodiments of the invention may therefore comprise a de-aerator, the boiler flow tapping being fluidly connected to the de-aerator (e.g. by a conduit such as a pipe). Since gas/air is removed, the liquid rate of flow within the central heating system may be substantially increased, e.g. by up to 70%, without the pumps suffering from the effects of cavitation and/or vibration.

In preferred embodiments, the vessel is a pressure tested vessel of generally square cross-section which acts in a natural heat exchanger capacity and is not reliant on electricity or any external controller to perform its function. The vessel may therefore be generally square in cross-section and/or may be completely hollow, e.g. devoid of baffles. A round vessel will not mix the liquid with the same efficiency. Multiple vessels may be added together to provide different sized system capacities.

Embodiments of the invention may be fitted to all types of wet central heating systems, including under-floor heating systems, and are compatible with all boiler and fuel types.

Embodiments of the invention can improve the efficiency of central heating systems which allows the system to offer energy savings and carbon savings by reducing fuel usage.

In combination with circulation pumps embodiments of the invention can increase the rate of liquid flow around the radiator circuit of the central heating system giving better and faster heat distribution.

The boiler flow into the invention may be downwards from a centrally placed tapping on the top of the vessel. The boiler flow tapping may therefore be centrally located on the top of the vessel. There is therefore ample opportunity to extract and collect gas/air micro bubbles from the central heating liquid within a dedicated ‘cap’. The central location of the boiler flow tapping also means that the collected bubbles are away from other tappings (such as the one or more boiler return tappings, radiator circuit tappings, etc.), so as not to re-introduce those bubbles into the system.

As the gas/air has been extracted from the system, the system pumps are able to circulate the liquid at a faster rate around the radiators without suffering from cavitation or knocking. This increased flow of the hot liquid results in the system radiators emitting their heat at optimum performance.

Embodiments of the invention may be designed to be installed within an existing or new wet central heating system between the boiler and the radiator system, which may include an under-floor coil. Embodiments of the invention may dampen the central heating system minimising power peaks and troughs caused by switching of the boiler. This can provide a greater heating ‘comfort factor’. Multiple vessels can be combined to accommodate larger systems.

The invention therefore makes a heating system more efficient and the amount of fuel burnt can be reduced without impacting on the heat distribution.

In preferred embodiments, the vessel comprises a layer of thermal insulation between an inner skin of the vessel and an outer skin of the vessel. The thermal insulation can significantly reduce the amount of unwanted heat loss from the vessel. The inner skin and/or outer skin may comprise steel. The inner skin may be stainless steel or may be (e.g. killed) mild steel. The steel may be treated with chromium oxide. The inner skin may therefore be substantially corrosion resistant. The outer skin may be powder-coated. The outer skin can provide protection to the thermal insulation and allow appropriate and clear connection markings (e.g. to the boiler, to the radiator circuits, etc.) to be applied to the outside of the vessel to assist with installation.

In preferred embodiments, the one or more boiler return tappings are provided through a side wall of the vessel. Similarly, in preferred embodiments, the radiator tappings are provided through a side wall of the vessel. The radiator tappings may comprise a radiator flow tapping and a radiator return tapping for each radiator circuit. The radiator flow tapping may be located on the top half of a side wall of the vessel and the radiator return tapping may be located on the bottom half of a side wall of the vessel.

In preferred embodiments, the vessel further comprises a drain tapping provided near the bottom of the vessel. This drain tapping can allow unwanted sludge and/or sediment that collects in the vessel to be drained from the vessel.

In preferred embodiments, one or more temperature sensors are attached to the boiler flow tapping and/or one or more boiler return tappings. Embodiments may further comprise a digital temperature display connected to the one or more temperature sensors. The display may be provided on top of the vessel or may be provided at a remote location. The display can provide a convenient way to monitor the temperatures of the boiler flow into and out of the vessel as provided by the one or more temperature sensors.

In preferred embodiments, the central heating product further comprises communication means for transmitting vessel identity data and/or temperature data provided by the one or more temperature sensors from the central heating product to a remote location. The communication means may comprise (short-range) wireless communication means, such as means for communicating via Bluetooth. The vessel identity and/or temperature data may be transmitted to a control unit at the remote location. The vessel identity may allow the vessel to be uniquely identified and “paired” with the control unit. The control unit may be configured to monitor the presence of the vessel, and alert an operator if communication with the vessel is lost (e.g. due to the vessel being uninstalled).

The present invention also extends to heating systems incorporating a vessel as herein described.

Thus, according to another aspect of the present invention there is provided a central heating system comprising a boiler and one or more radiator circuits, the central heating system further comprising:

a central heating product as described herein plumbed between the boiler of the central heating system and the one or more radiator circuits of the central heating system.

The central heating system may further comprise: a water cylinder fluidly connected between the boiler and the vessel; and a by-pass fluidly connected between the boiler and the vessel, the by-pass comprising a gate valve, wherein the gate valve is operable such that flow from the boiler can be selectively either directed to the vessel via the water cylinder or directed to the vessel via the by-pass. This can allow water within the water cylinder to be selectively heated by the boiler.

According to another aspect of the present invention there is provided a method of installing or modifying a central heating system that comprises a boiler and one or more radiator circuits, the method comprising:

plumbing a central heating product as described herein between the boiler of the central heating system and the one or more radiator circuits of the central heating system.

By way of example only, embodiments of the present invention will now be described in more detail with reference to the accompanying drawings in which:

FIG. 1 is a front elevation of an embodiment of vessel of the present invention;

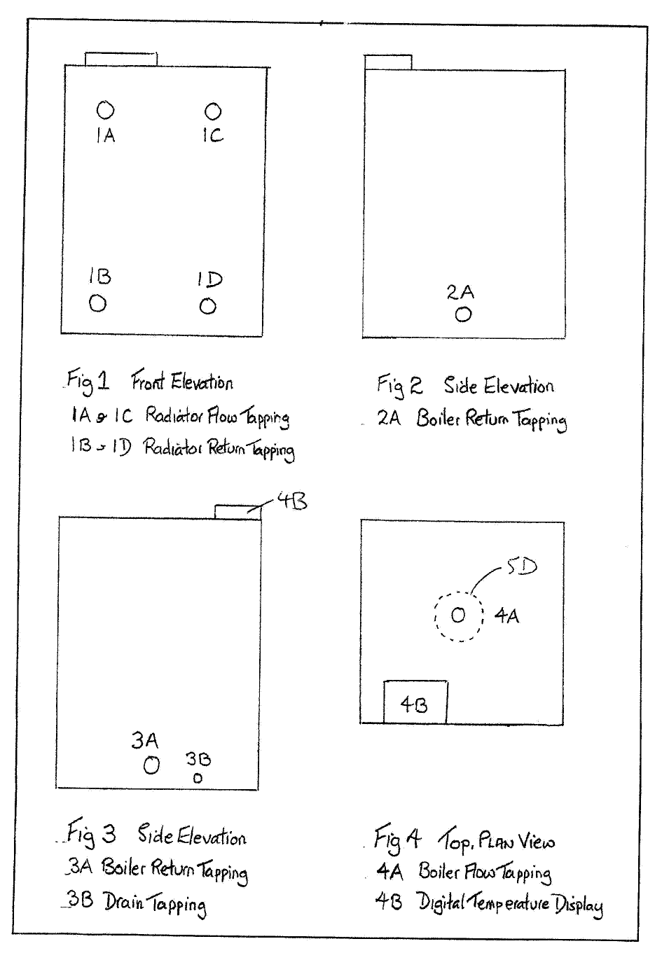

FIG. 2 is a side elevation of the embodiment of FIG. 1;

FIG. 3 is an opposite side elevation of the embodiment of FIG. 1;

FIG. 4 is a top plan view of the embodiment of FIG. 1;

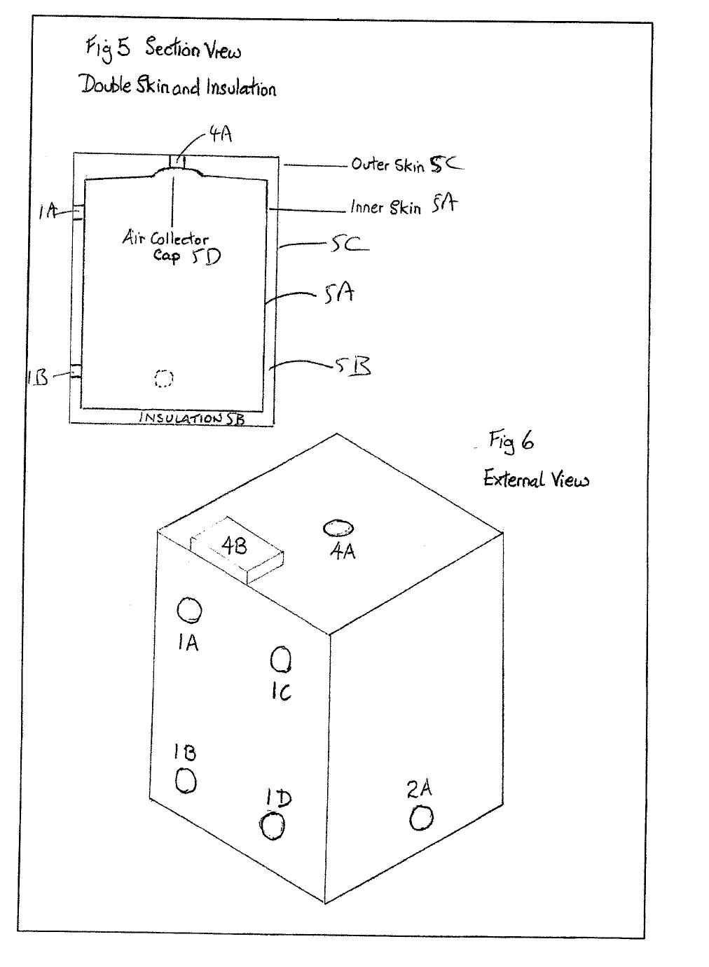

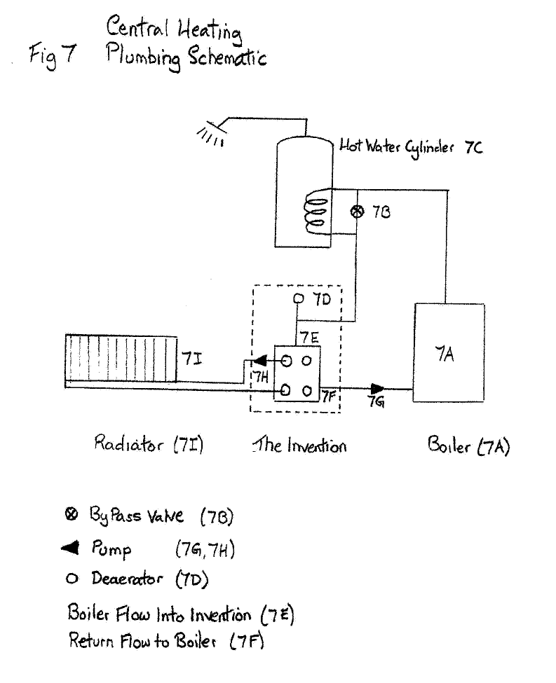

FIG. 5 is a vertical section of the embodiment of FIG. 1;

FIG. 6 is an external view of the embodiment of FIG. 1;

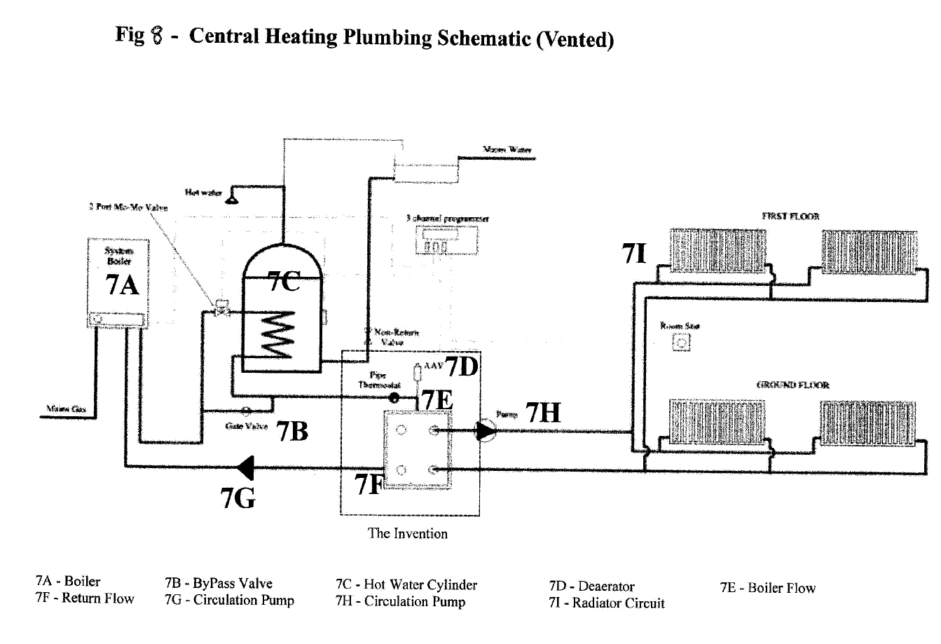

FIG. 7 is a schematic view of a central heating system comprising the vessel of FIGS. 1-6; and

FIG. 8 is an alternative schematic view of a central heating system comprising the vessel of FIGS. 1-6.

In the present embodiment, the vessel of the invention is a pressure tested steel vessel with an approximate 1:1:1.25 dimension ratio. The vessel comprises an inner skin of steel 5A, a layer of thermal insulation 5B and an outer steel powder coated casing 5C (see FIG. 5). The internal skin is completely hollow and square in plan. This means there are no requirements for baffle plates, in-line emergency vents or controllers. The steel vessel comprises a thick layer of thermal insulation 5B which minimises heat loss and increases efficiency.

A further important feature is the shape of an upper part 5D of the inner skin 5A which defines a gas/air bubble catchment area. That extends up towards the base of one of the tappings within the cavity in the vessel and makes a gas/air collector cap that will release gas/air. These features add to the efficiency of embodiments of the invention.

Eight tappings are placed in different locations on the vessel (see FIGS. 1, 2, 3, 4 and 6) allowing it to be connected into an existing central heating system between the boiler and the first radiator (see FIG. 7 or FIG. 8).

The inner skin is specifically treated with a layer of chromium oxide which is formed when in contact with water. This eliminates the chemical reaction that is responsible for surface corrosion thus protecting the vessel. If this layer is damaged the steel is able to repair the layer itself by the oxidation process.

The vessel has a square footprint with plumbing tappings (1A, 1B 1C 1D 2A 3A 4A) that are used to connect to the boiler, hot water cylinder and radiator circuits. The boiler flow enters the vessel from the top and in a downwards vertical direction via a centrally positioned tapping 4A that has dual functionality. A unique feature of this vessel for it to work most efficiently within the proposed design is that this tapping is centrally located (see FIG. 4).

The first function of the tapping is to ensure that that the fluid dynamics is one of a vertical motion as it enters the vessel. This flow as it enters into the chamber helps to promote the removal of microbubbles from the liquid flowing from the boiler. The vessel is uniquely sculptured with a purpose built bubble capture area under the tapping to aid collection of the gas/air before it is released via a de-aerator (see FIG. 4, 4A).

The second function involves utilising the same tapping but this time in the opposite direction. Whenever the boiler is stagnant there will be no flow into the chamber. This then allows any gas/air bubbles that will have collected in the bubble catchment area below the tapping 4A to then escape out of the chamber and system into the environment via a de-aerator. Removal of gas/air from the boiler flow in this manner is a unique feature of embodiments of the invention.

In a side wall there are tappings 1A,1B and 1C,1D for two separate radiator circuits each comprising a separate flow tapping (1A 1C) and return tappings (1B 1D) as well as two separate boiler return tappings (2A 3A). The radiator flow tappings are located in the top half of the side wall of the vessel and the radiator and boiler return tappings are located in the bottom half of the sidewall of the vessel. This arrangement provides a unique feature that allows the vessel to supply multiple radiator zones or circuits and also to be heated by one or more boilers. Any of the radiator or boiler tappings may be blanked off if not being used.

The unique square internal cavity, along with the location of the tappings, allows the vessel to abide by Bernoulli's principle and work as a natural (passive) heat exchanger with a high efficiency in a way that has not been captured in a central heating system before.

Finally, there is also the inclusion near the bottom of a desludging outlet 3B to allow for the efficient draining of the system and allowing the extraction of any sludge or sediment build up that will be collected in the bottom of the vessel from time to time.

Condensing boilers are now largely replacing earlier conventional designs in powering domestic central heating systems. In the UK since 2005 all new gas central heating boilers must be high efficiency condensing boilers and the same applies to oil fired boilers from April 2007. However, a condensing boiler will only condense to maximum efficiency if the temperature of the liquid return flow is lower than the relevant dew point.

Typically system design, installation problems and/or product limitations mean that boilers are installed with a high flow temperature (usually between 75° C. and 87° C.) to try and make the system effective. The result, however, is that the return temperature to the boiler may be above the relevant dew point and therefore the boiler will not be in the very efficient condensing mode. A unique feature of embodiments of the invention is that they enable a system to now be set up so that the flow temperature can be reduced meaning less fuel is used by the boiler, whilst increasing the comfort factor from the central heating system. Lastly it also enables the return flow to now reach the desired temperature of below the relevant dew point. This is a unique feature of embodiments of the invention.

Another unique feature of embodiments of the invention is that they achieve good results without the need for a controller or control unit. What some embodiments of the invention have as part of their design is two temperature sensors that are attached during manufacture to the boiler flow and return tappings on the vessel. These are connected to digital displays 4B placed on the top of the vessel to provide a visual check on the two different running temperatures of the liquid.

The system can therefore be easily monitored and regulated via the boiler as required to ensure optimum performance and maximum energy savings. For example, the boiler flow temperature can be set to ensure that, after passing through the vessel, the return boiler flow temperature will facilitate a condensing boiler to run at its optimum. As a further consequence carbon emissions will also be reduced.

If a water cylinder 7C is included in the central heating system a by-pass with an open gate valve 7B is added so that hot water from the boiler 7A is directed simultaneously to the cylinder and the vessel. This novel design ensures there is no requirement for a controller and potable water can also be heated.

1. A central heating product comprising a vessel for plumbing between a boiler of a central heating system and one or more radiator circuits of the central heating system, the vessel comprising:
a boiler flow tapping at the top of the vessel for flow into the vessel from the boiler;
one or more boiler return tappings for return flow to the boiler from the vessel;
radiator tappings for fluid connection with the one or more radiator circuits; and
means for collecting gas/air for expulsion from the central heating system, the means for collecting gas/air comprising a domed bubble catchment area that is defined by an upper part of the vessel and provided under the boiler flow tapping and a de-aerator. the boiler flow tapping being fluidly connected to the de-aerator:
wherein the vessel is generally square in cross-section.

2. A central heating product as claimed in claim 1, wherein the boiler flow tapping is centrally located on the top of the vessel.

3. (canceled)

4. (canceled)

5. A central heating product as claimed in claim 1, wherein the vessel is completely hollow.

6. A central heating product as claimed in claim 1, wherein the vessel comprises a layer of thermal insulation between an inner skin of the vessel and an outer skin of the vessel.

7. A central heating product as claimed in claim 6, wherein the inner skin and/or outer skin comprises steel.

8. A central heating product as claimed in claim 6, wherein the inner skin is treated with chromium oxide and/or the outer skin is powder-coated.

9. A central heating product as claimed in claim 1, wherein the one or more boiler return tappings are provided through a side wall of the vessel.

10. A central heating product as claimed in claim 1, wherein the radiator tappings are provided through a side wall of the vessel.

11. A central heating product as claimed in claim 1, wherein the radiator tappings comprise a radiator flow tapping and a radiator return tapping for each radiator circuit.

12. A central heating product as claimed in claim 11, wherein the radiator flow tapping is located on the top half of a side wall of the vessel and the radiator return tapping is located on the bottom half of a side wall of the vessel.

13. A central heating product as claimed in claim 1, the vessel further comprising a drain tapping provided at or adjacent the bottom of the vessel.

14. A central heating product as claimed in claim 1, further comprising one or more temperature sensors attached to the boiler flow tapping and/or to the one or more boiler return tappings.

15. A central heating product as claimed in claim 14, further comprising a digital temperature display connected to the one or more temperature sensors.

16. A central heating product as claimed in claim 1, further comprising communication means for transmitting vessel identity data and/or temperature data provided by the one or more temperature sensors from the central heating product to a remote location.

17. A central heating product as claimed in claim 16, wherein the communication means comprises wireless communication means.

18. (canceled)

19. A central heating system comprising a boiler and one or more radiator circuits, the central heating system further comprising:
a central heating product as claimed in claim 1 plumbed between the boiler of the central heating system and the one or more radiator circuits of the central heating system.

20. A central heating system as claimed in claim 19, further comprising:
a water cylinder fluidly connected between the boiler and the vessel; and
a by-pass fluidly connected between the boiler and the vessel, the by-pass comprising a gate valve, wherein the gate valve is operable such that flow from the boiler can be selectively either directed to the vessel via the water cylinder or directed to the vessel via the by-pass.

21. (canceled)

22. A method of installing or modifying a central heating system that comprises a boiler and one or more radiator circuits, the method comprising:
plumbing a central heating product as claimed in claim 1 between the boiler of the central heating system and the one or more radiator circuits of the central heating system.

23. (canceled)
